(19) United States
(12) Patent Application Publication
(10) Pub. No.: US 2011/0032696 A1
(43) Pub. Date: Feb. 10, 2011

(54) Led lighting lamp

(76) Inventors: Min Kong Kim, Seoul (KR); Min Sup Yoon, Seoul (KR)

Correspondence Address: HARNESS, DICKEY & PIERCE, P.L.C., P.O. BOX 828, BLOOMFIELD HILLS, MI, 48303, US

(21) Appl. No.: 12/587,899

(22) Filed: Oct. 14, 2009

(30) Foreign Application Priority Data
Aug. 4, 2009 (KR) 20-2009-0010183

(51) Int. Cl. F21L 4/02

(52) U.S. Cl. 362/184

(57) ABSTRACT

Provided is an LED lighting lamp which is installed at an electric pole or a wall surface. The LED lighting lamp includes a fixing frame having a fixing bracket which is fixedly installed at an electric pole or a wall surface; a pair of LED housings which are installed at both side surfaces of the fixing frame so as to be rotated about a shaft parallel with a length direction of the fixing frame, and in which an LED panel having a plurality of LEDs is installed; and a power supplying unit which is provided at the fixing frame so as to supply current to the LED panel.

### CROSS-REFERENCE(S) TO RELATED APPLICATIONS

The present invention claims priority of Korean Patent Application No. 20-2009-10183, filed on Aug. 4, 2009, which is incorporated herein by reference.

### BACKGROUND OF THE INVENTION

1. Field of the Invention

The present invention relates to an LED lighting lamp such as a street light and a lighting lamp which is provided at a high wall surface of a building; and, more particularly, to an LED lighting lamp which can adjust a lighting angle so as to minimize a dead spot of the lighting lamp due to difference in a distance between the lighting lamps.

2. Description of Related Art

Recently, as the concerns about the squandering of resources due to overconsumption of energy and the energy saving are increased, it is actively recommended or performed to replace a fluorescent lamp, an incandescent electric lamp or a neon lamp with an LED (or LED lighting lamp) having relatively high brightness and low power consumption.

As described above, since the LED lighting lamp (a lamp comprised of a plurality of LEDs) has the low power consumption and high brightness, it is widely used as a lighting lamp such as a traffic light and an advertising-light. Further, it is replaced or will be replaced with the lighting lamp (e.g., a fluorescent lamp or an incandescent electric lamp) of the existing lighting equipment.

However, the LED lighting lamp has the higher brightness than the existing lamp, but also has a narrow lighting range. Therefore, as shown in FIG. 1, if the LED lighting lamp is replaced with the existing neon light and used as a street light 200, a dead spot may be generated between the street lights 200.

In other words, since the existing street lights 200 are arranged on the basis of the neon lamp having a relatively wide lighting range (as illustrated by a solid line), if the LED lighting lamp is applied to the street light 200, the lighting range becomes narrow (as illustrated by a dot line), and thus the dead spot is generated.

Therefore, as shown in FIG. 2, there has been proposed an LED panel 220 of the LED lighting lamp 210, which is formed into a curved shape so as to expand the lighting range. However, since the curved shaped LED panel 220 has some disadvantages in that it is difficult to install other electronic parts therein and it is difficult to manufacture it, it is not widely applied to the lighting equipment.

### SUMMARY OF THE INVENTION

An embodiment of the present invention is directed to providing an LED lighting lamp which can be facilely installed to the exiting lighting equipment and also minimize the generation of the dead spot when it is applied to the exiting lighting equipment.

To achieve the object of the present invention, the present invention provides an LED lighting lamp, comprising a fixing frame having a fixing bracket which is fixedly installed at an electric pole or a wall surface; a pair of LED housings which are installed at both side surfaces of the fixing frame so as to be rotated about a shaft parallel with a length direction of the fixing frame, and in which an LED panel having a plurality of LEDs is installed; and a power supplying unit which is provided at the fixing frame so as to supply current to the LED panel.

Preferably, the LED housing comprises a body portion which has a [symbol] -shape in section and a plurality of heat radiating fins formed on an outer surface thereof so as to radiate heat generated from the LED panel to an outside, and which is fabricated in an extrusion molding method, and a cover portion which is coupled to both ends of the body portion and also has a plurality of heat radiating fins formed on an outer surface thereof.

Preferably, the fixing frame or the LED housing further comprises a fixing means for fixing a rotated position of each LED housing.

Preferably, the fixing frame and the LED housing are respectively provided with one of a shaft member as a rotational center of the LED housing and a connection member which rotatably receives the shaft member, and the fixing means is a bolt which is fastened to the connection member so as to be protruded to the shaft member. Preferably, the connection member which has a first curved portion having a C-shape in section and a through-hole extended from the first curved portion to an inside of the fixing frame is installed at or integrally formed with left and right sides of the fixing frame, a second curved portion which has a C-shape in section having a smaller diameter than the first curved portion so as to be partially received in the first curved portion is formed at a side surface of the LED housing, a cylindrical shaft member which is radially formed with a connection hole corresponding to the through-hole is further installed at an inside of the second curved portion, and a position of the second curved portion fitted between the first curved portion and the shaft member is fixed of adjusted according to a tightening or loosening status between a nut and a bolt which is inserted through the through-hole and the connection hole.

### BRIEF DESCRIPTION OF THE DRAWINGS

FIG. 1 is a schematic view showing each lighting range of a conventional street lamp and an LED lighting lamp.

FIG. 2 is a schematic view showing the conventional LED lighting lamp which is used as an external lighting lamp or the street lamp of FIG. 1.

FIG. 3 is an exploded perspective view of an LED lighting lamp according to a first embodiment of the present invention.

FIG. 4 is an assembled perspective view of the LED lighting lamp of FIG. 3.

FIG. 5 is a partial cross-sectional view showing a connectional portion of a fixing frame and an LED housing of FIG. 4.

FIGS. 6 and 7 schematic views showing each installation example of the LED lighting lamp of FIG. 4.

FIG. 8 is an exploded perspective view of an LED lighting lamp according to a second embodiment of the present invention.

FIG. 9 is a partial cross-sectional view showing a connectional portion of a fixing frame and an LED housing according to the second embodiment of the present invention.

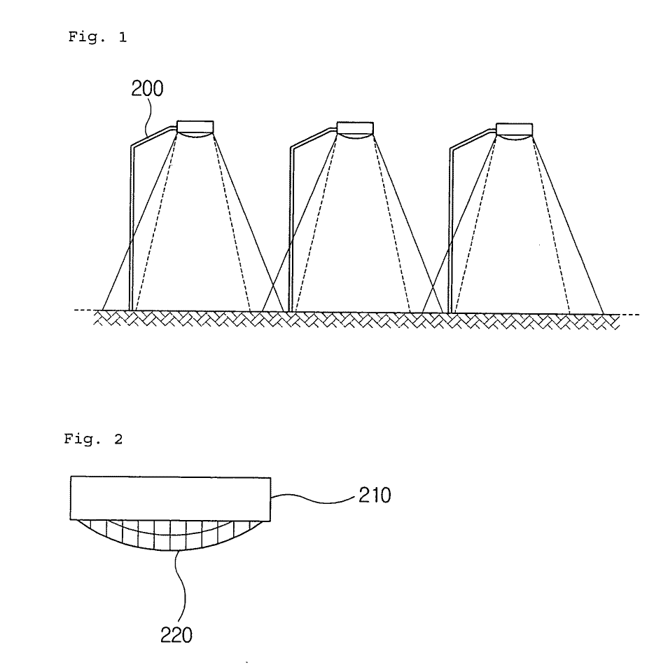

### DESCRIPTION OF SPECIFIC EMBODIMENTS

The advantages, features and aspects of the invention will become apparent from the following description of the embodiments with reference to the accompanying drawings, which is set forth hereinafter.

### First Embodiment

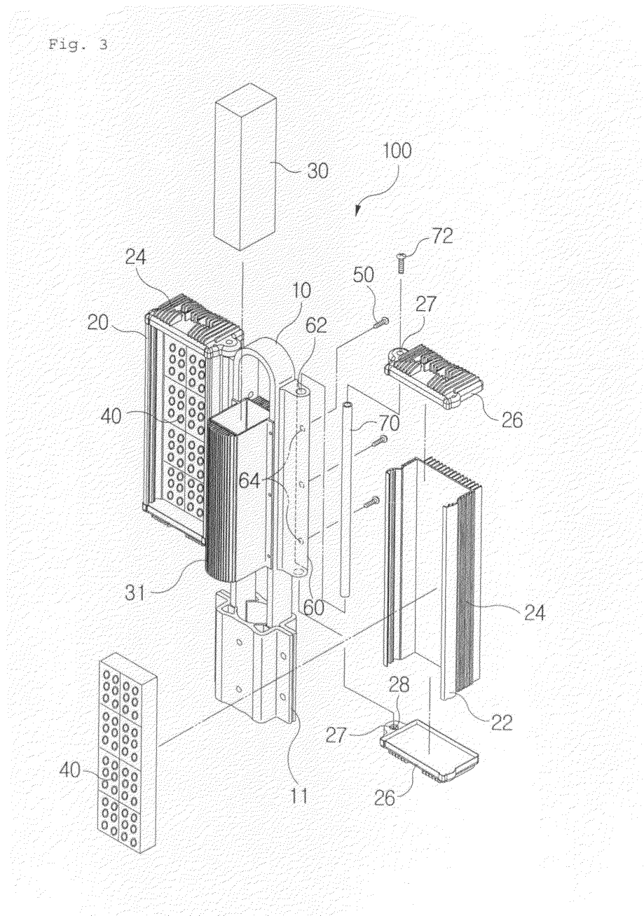

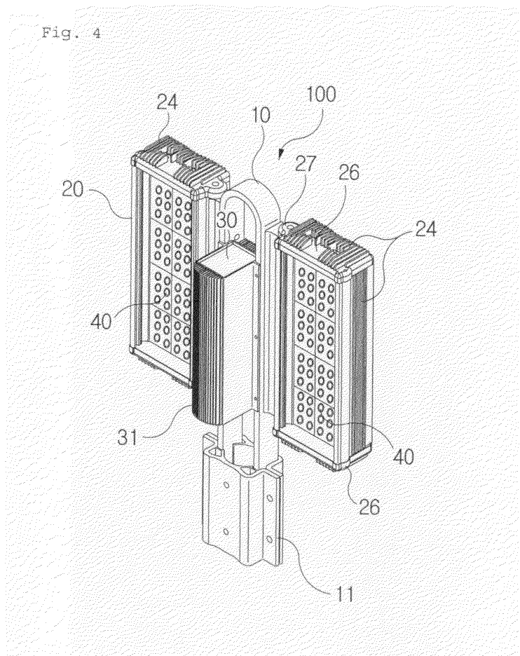

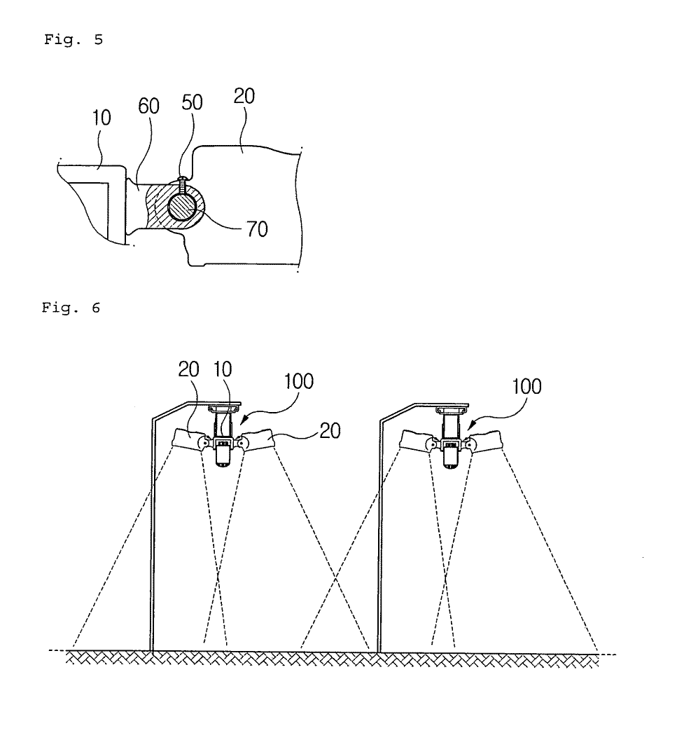

FIG. 3 is an exploded perspective view of an LED lighting lamp according to a first embodiment of the present invention, FIG. 4 is an assembled perspective view of the LED lighting lamp of FIG. 3, FIG. 5 is a partial cross-sectional view showing a connectional portion of a fixing frame and an LED housing of FIG. 4 and FIGS. 6 and 7 schematic views showing each installation example of the LED lighting lamp of FIG. 4.

As shown in FIGS. 3 and 4, an LED lighting lamp 100 according to a first embodiment of the present invention includes a fixing frame 10, a pair of LED housings 20, a power supplying unit 30, a pair of LED panels 40, a pair of connection members 60 and a pair of shaft members 70.

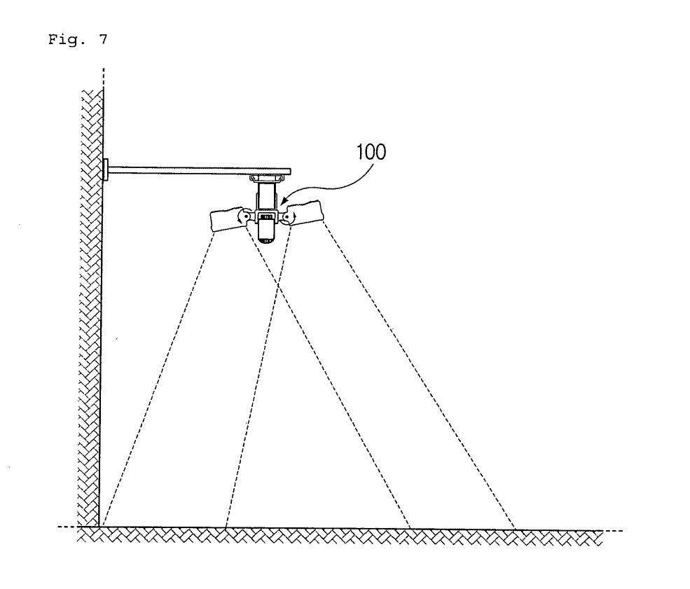

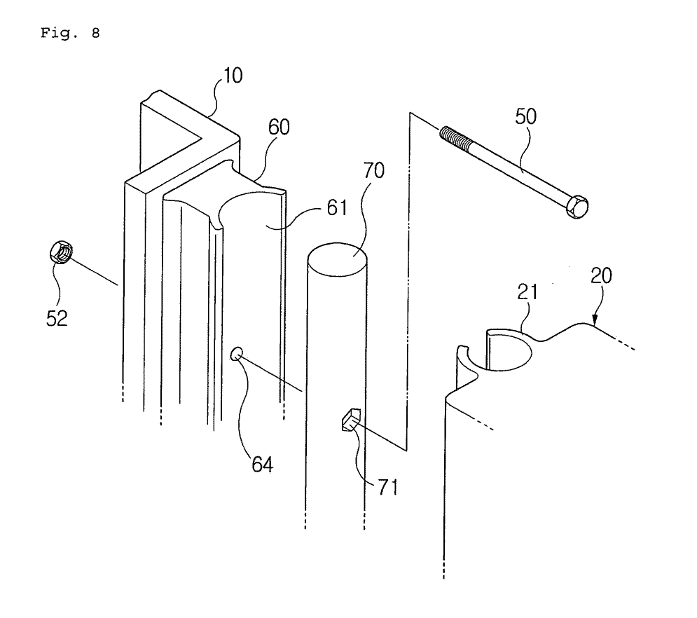

The fixing frame 10 as a member forming a basic body of the LED lighting lamp 100 is formed into a rectangular parallelepiped shape of which a surface (a front surface of FIG. 3) is opened so as to receive other members or units. The fixing frame 10 is installed to an electric pole (referring to FIG. 6) of the street lamp 200 or a wall surface (referring to FIG. 7) via a bracket and the like. Meanwhile, the fixing frame 10 may be modified or changed within an extent that the LED housing 20 can be disposed at one or both sides of the fixing frame 10 and also the power supplying unit can be received therein. The fixing frame 10 further includes a fixing bracket 11 which is fixed to the wall surface or other members.

The LED housing 20 is a member in which the LED panel 40 is substantially installed. The LED housing 20 is formed into a rectangular parallelepiped shape and installed at both side surfaces of the fixing frame 10. The LED housing 20 is formed of aluminum or an aluminum alloy so as to facilely radiate heat generated from the LED panel 40 to an outside, and also has a plurality of heat radiating fins 24.

On the other hands, as shown in FIG. 3, the LED housing 20 includes a body portion 22 and a pair of cover portions 26. The body portion 22 is a elongated member having a t-shape in section and fabricated in an extrusion molding method according to a capacity of the lighting equipment to be installed. As described above, the plurality of heat radiating fins 24 are formed on an outer surface of the body portion 22 in a length direction thereof. The pair of cover portions 26 is formed into a rectangular shape and disposed at both ends (upper and lower ends in FIG. 3) of the body portion 22. The plurality of heat radiating fins 24 are also formed on an outer surface of the cover portion 26. A protrusion 27 is formed at one side (a surface or a direction opposite to the fixing frame 10) of the cover portion 26 so as to be protruded toward the fixing frame 10. The protrusion 27 is formed with a hole 28 through which the shaft member 70 or a bolt 72 is inserted.

The power supplying unit 30, as a device for stably supplying current (e.g., constant current) to the LED panel 40, is provided in the fixing frame 10 and functions to supply the current to the LED panel 40 disposed in the LED housing 20. To this end, the power supplying unit 30 is connected with the LED panel 40 through a separate electric wire (not shown) and also connected with an external main power source and an subsidiary power source (for example, a storage battery for emergencies, e.g., when the power gives out). For the purpose of reference, SMPS (Switching Mode Power Supply) may be used as the power supplying unit 30. In the embodiment, the power supplying unit 30 is installed to the fixing frame 10 through a power supplying unit housing 31, as shown in FIG. 3. The power supplying unit housing 31 may be not provided according to circumstances. In this case, the power supplying unit 30 is directly installed to the fixing frame 10.

The LED panel 40 has a plurality of LEDs arranged in a matrix and functions to emit light according to whether the current is supplied from the power supplying unit 30. The LED panel 40 is provided in the LED housing 20. Preferably, four side surfaces and a rear surface of the LED panel 40 are closely contacted with inner surfaces of the body portion 22 so that the heat generated from the LED panel 40 can be smoothly transferred to the LED housing 20. For the purpose of reference, the coupling between the LED panel 40 and the LED housing 20 is achieved through an adhesive or other attaching means.

The connection member 60 is provided at both side surfaces of the fixing frame 10 (in FIG. 3) and functions to connect the fixing frame 10 and the LED housing 10. The connection member 60 is formed with a space (referring to FIG. 5) in which the shaft member 70 can be received. Further, at a side surface of the connection member 60 (referring to FIG. 3), there are formed a plurality of coupling holes 64 which is communicated with an inside of the connection member 60 and through which a fixing means 5 (hereinafter, ‘bolt’) is coupled. And at upper and lower sides of the connection member 60, there is a shaft coupling hole 62 through which the shaft member 70 is inserted. The connection member 60 may be integrally formed with the fixing frame 10 or fixedly coupled to the fixing frame 10 by welding or bolt coupling.

The shaft member 70 functions to allow the LED housing to be rotated with respect to the fixing frame 10. The shaft member 70 is positioned at an inner space of the connection member 60 and, at the same time, fixedly coupled to the LED housing 20. More detailedly, a body of the shaft member 70 is positioned at an inside of the connection member 60, but both ends of the shaft member 70 are respectively fixed to the pair of cover portions 26 through a bolt 72. Therefore, the shaft member 70 can not be rotated with respect to the LED housing 20, but can be rotated with respect to the connection member 60. Meanwhile, as shown in FIG. 5, a position of the LED housing 20 rotated by the shaft member 70 can be fixed by the bolt 50 fixed to the connection member 60.

The LED lighting lamp 100 of the present invention, as described, above has an assembled shape as shown in FIG. 4. In the LED lighting lamp 100, the LED housing 20 in which the LED panel 40 is installed can be rotated at a desired angle with respect to the fixing frame 10 by the coupling structure of the connection member 60 and the shaft member 70. Therefore, a user can adjust a lighting range by controlling an rotating angle of the LED housing 20 according to using purpose and used place of the LED lighting lamp 100.

In other words, as shown in FIG. 6, when the LED lighting lamp 100 of the present invention is applied to an existing equipment, it can be prevented that the lighting ranges of adjacent street lamps 200 are overlapped or a dead spot of the lighting range is generated.

Further, as shown in FIG. 7, the LED lighting lamp 100 of the present invention is provided at a vertical wall surface, such that the light from the LED panel 40 is not emitted to the wall surface or other unnecessary places. Therefore, it is possible to maximize and optimize an lighting efficiency of the lighting lamp.

### Second Embodiment

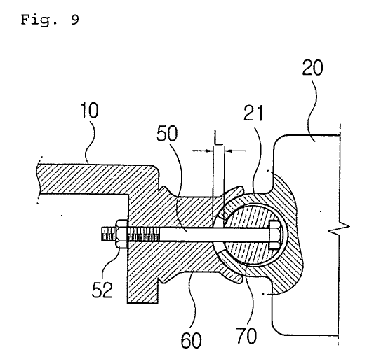

FIG. 8 is an exploded perspective view of an LED lighting lamp according to a second embodiment of the present invention, and FIG. 9 is a partial cross-sectional view showing a connectional portion of a fixing frame and an LED housing according to the second embodiment of the present invention.

An LED lighting lamp according to a second embodiment of the present invention has the same construction elements as that of the first embodiment, except the LED housing 20, the connection member 60 and the shaft member 70. The description of the same elements will be omitted, and the same elements are designated by the same reference numeral as those in the first embodiment.

In the embodiment, as shown in FIG. 8, a second curved portion 21 having a C-shape in section is formed at a side surface (a surface opposite to the fixing frame 10) of the LED housing 20. The second curved portion 21 is elongated in a length direction of the LED housing 20 and partially received in a first curved portion 61 of the connection member 60 to be described later.

The connection member 60 has a first surface (a surface opposite to the fixing frame 10) which is flat and a second surface (a surface opposite to the LED housing 20) which is curved. The second surface (hereinafter, called ‘first curved portion 61’) of the connection member 60 has a C-shape in section and also has a larger diameter than the second curved portion 21 so as to receive the second curved portion 21. Meanwhile, the connection member 60 is formed with a through-hole 64 which is extended from the first curved portion 61 to the fixing frame 10 (a hole corresponding to the through-hole 64 is formed at a side surface of the fixing frame 10). As described in the first embodiment, the connection member 60 may be detachably coupled with the fixing frame 10, and if necessary, integrally formed with the fixing frame 10.

The shaft member 70 is formed into an elongated cylindrical shape like in the first embodiment, and also formed with a connection hole 71 which is passed through in a radial direction of the shaft member 70. The connection hole 71 is formed to be connected with the through-hole 64 of the connection member 60. Preferably, one side of the connection hole 71 is formed into a polygonal shape which is the same as a head portion of the bolt 50, so that the head portion of the bolt 50 is fixed inserted therein.

The bolt 50 is inserted through the connection hole 71 of the shaft member 70, the through-hole of the connection member 60 and the hole (not shown) of the fixing frame 10. An end of the bolt 15 protruded to an inside of the fixing frame 10 is fastened by a nut 52.

Hereinafter, a rotational structure of the LED housing 20 of the LED lighting lamp 100 will be described.

In the LED lighting lamp 100 according to the second embodiment of the present invention, a connection structure between the fixing frame 10 and the LED housing 20 has a shape shown in FIG. 9. That is, the second curved portion 21 of the LED housing 20 is received in the first curved portion 61 of the connection member 60 so as to be fitted between the first curved portion 61 and the shaft member 70. Herein, a distance L between the first curved portion 61 and an outer surface of the shaft member 70 is changed according to a fastening degree of the bolt 50 and the nut 52.

If the nut 52 fastened to the bolt 50 is loosened so as to secure an enough distance L between the first curved portion 61 and the shaft member 70, the LED housing 20 can be rotated via the second curved portion 21 that is moved along a curved surface of the first curved portion 61 (herein, the shaft member 70 is a rotational center).

On the other hand, if the nut 52 fastened to the bolt 50 is tightened, in a status that the LED housing 20 is rotated at a desired angle, so as to close the distance L between the first curved portion 61 and the shaft member 70, the second curved portion 21 of the LED housing 20 is fixed between the first curved portion 61 of the connection member 20 and the shaft member 70, and the rotated position of the LED housing 20 is fixed.

As described above, since the rotated position of the LED housing 20 is firmly fixed by the connection member 60 and the shaft member 70, it is possible to surely secure the rotated position of the LED housing 20 even though a large number of LEDs are installed in the LED housing 20.

According to the present invention, since the lighting lamp can be facilely installed in an existing lighting equipment, it is possible to minimize the dead spot which is generated by replacing the existing street lamp and the like with the LED lighting lamp.

Therefore, it is facile to replace the existing outworn lighting lamp having a high power consumption with the LED lighting lamp, thereby maximizing the energy saving effect.

While the present invention has been described with respect to the specific embodiments, it will be apparent to those skilled in the art that various changes and modifications may be made without departing from the spirit and scope of the invention as defined in the following claims.

What is claimed is:

1. An LED lighting lamp, comprising:
a fixing frame having a fixing bracket which is fixedly installed at an electric pole or a wall surface;
a pair of LED housings which are installed at both side surfaces of the fixing frame so as to be rotated about a shaft parallel with a length direction of the fixing frame, and in which an LED panel having a plurality of LEDs is installed; and
a power supplying unit which is provided at the fixing frame so as to supply current to the LED panel.

2. The LED lighting lamp of claim 1, wherein the LED housing comprises:
a body portion which has a [symbol] -shape in section and a plurality of heat radiating fins formed on an outer surface thereof so as to radiate heat generated from the LED panel to an outside, and which is fabricated in an extrusion molding method, and
a cover portion which is coupled to both ends of the body portion and also has a plurality of heat radiating fins formed on an outer surface thereof,
wherein the fixing frame or the LED housing further comprises a fixing means for fixing a rotated position of each LED housing.

3. The LED lighting lamp of claim 2, wherein the fixing frame and the LED housing are respectively provided with one of a shaft member as a rotational center of the LED housing, and a connection member which rotatably receives the shaft member, and
the fixing means is a bolt which is fastened to the connection member so as to be protruded to the shaft member.

4. The LED lighting lamp of claim 2, wherein the connection member which has a first curved portion having a C-shape in section and a through-hole extended from the first curved portion to an inside of the fixing frame is installed at or integrally formed with left and right sides of the fixing frame,
a second curved portion which has a C-shape in section having a smaller diameter than the first curved portion so as to be partially received in the first curved portion is formed at a side surface of the LED housing,
a cylindrical shaft member which is radially formed with a connection hole corresponding to the through-hole is further installed at an inside of the second curved portion, and
a position of the second curved portion fitted between the first curved portion and the shaft member is fixed of adjusted according to a tightening or loosening status between a nut and a bolt which is inserted through the through-hole and the connection hole.
